(19) United States
(12) Patent Application Publication
(10) Pub. No.: US 2011/0168128 A1
(43) Pub. Date: Jul. 14, 2011

(54) System for Variable Blending Of Ethanol And Exhaust Water For Use As An Anti-Knock Agent

(75) Inventors: John Bradley, Cambridge, MA (US); Leslie Bromberg, Sharon, MA (US); Daniel Cohn, Cambridge, MA (US)

(73) Assignee: ETHANOL BOOSTING SYSTEMS LLC, Cambridge, MA (US)

(21) Appl. No.: 12/823,468

(22) Filed: Jun. 25, 2010

Related U.S. Application Data
(60) Provisional application No. 61/220,643, filed on Jun. 26, 2009.
(60) Provisional application No. 61/230,277, filed on Jul. 31, 2009.

(51) Int. Cl. F02M 25/025; F02M 61/16

(52) U.S. Cl. 123/294; 123/434

(57) ABSTRACT

The present application describes systems for water retrieval from the engine exhaust. This collected water can be used both for removing ethanol from ethanol-gasoline blends, and for use as a knock suppressant. The water that is removed from the exhaust can be used as the only source of water or in combination with water that is externally supplied. The present application also describes new means for removal of water from the exhaust that can be employed for applications. In some embodiments, an auto-heat exchanger is employed to recover water from the engine exhaust.

This application claims priority of U.S. Provisional Patent Application Ser. No. 61/220,643, filed Jun. 26, 2009 and U.S. Provisional Patent Application Ser. No. 61/230,277, filed Jul. 31, 2009, the contents of both are incorporated herein by reference.

### BACKGROUND OF THE INVENTION

Water and water-ethanol mixtures can serve as highly effective anti-knock agents when directly injected into a spark ignition engine. However, it may be inconvenient to store large amounts of water onboard the vehicle. Therefore, it can be advantageous to eliminate or substantially reduce the amount of water that needs to be supplied from an external source and stored onboard the vehicle. One way that this can be accomplished is by retrieving water from the exhaust. Water that is extracted from engine exhaust can also be used to reduce emissions in diesel engines.

Retrieval of water from the exhaust has been considered for multiple applications. For example, the military is interested in obtaining potable water from engine exhaust, in order to minimize potable water logistics, and have developed several systems for capturing the water. For example, a hydrophilic fluid to collect the water has been suggested, with water/hydrophilic fluid separation downstream. Another system uses a membrane for water condensation and collection.

Water recovery from the exhaust, with the water mixed with the fuel, has also been discussed in the prior art. The water is removed from the exhaust and mixed with the gasoline, for improved combustion, emissions, and efficiency.

Other concepts for retrieval of water from the exhaust teach water condensation from clean exhaust and further cleanup.

Yet other references teach the use of a small amount of directly injected ethanol and water from a second tank for suppression of knock. The liquid from the second tank is only used when and in the amount needed to prevent knock. The knock suppression enables highly turbocharged, high compression ratio spark ignition engine operation and thus makes possible diesel engine like efficiency in spark ignition engines. Water can also be used as an extractant of the alcohol in alcohol-gasoline blends. The resulting alcohol-water mixture can be used as an antiknock agent.

The amount of water-alcohol mixture that is needed for knock suppression over a typical drive cycle can be very small, roughly on the order of 1% of the volumetric flow of the gasoline, However, substantial amounts of water-alcohol mixture may be required during high torque operation, such as on the order of 10-50% of the volumetric flow rate of the gasoline. Although there are mitigation techniques for decreasing the required amount of antiknock agent, such as up-speeding, aggressive spark retard, rich operation, and others, these techniques also decrease fuel efficiency. Therefore, it would be desirable to have a system that can provide the antiknock agent without requiring frequent refueling of a second tank, due in part due to the lack of a widespread refueling infrastructure.

### SUMMARY OF THE INVENTION

The present application describes systems for water retrieval from the engine exhaust. This collected water can be used both for removing ethanol from ethanol-gasoline blends, and for use as a knock suppressant. The water that is removed from the exhaust can be used as the only source of water or in combination with water that is externally supplied. The present application also describes new means for removal of water from the exhaust that can be employed for applications, such as the military applications described previously.

### BRIEF DESCRIPTION OF THE DRAWINGS

FIGS. 1a-b shows two embodiments in accordance with the present invention.

FIG. 2 shows an auto-heat-exchanger used for the present application.

FIG. 3 shows a tank system where water/alcohol mixtures are stored in same tank as the fuel.

FIG. 4 shows a tank system for externally supplied non-water fluid and for externally supplied water, or water recovered from exhaust gas.

### DETAILED DESCRIPTION OF THE INVENTION

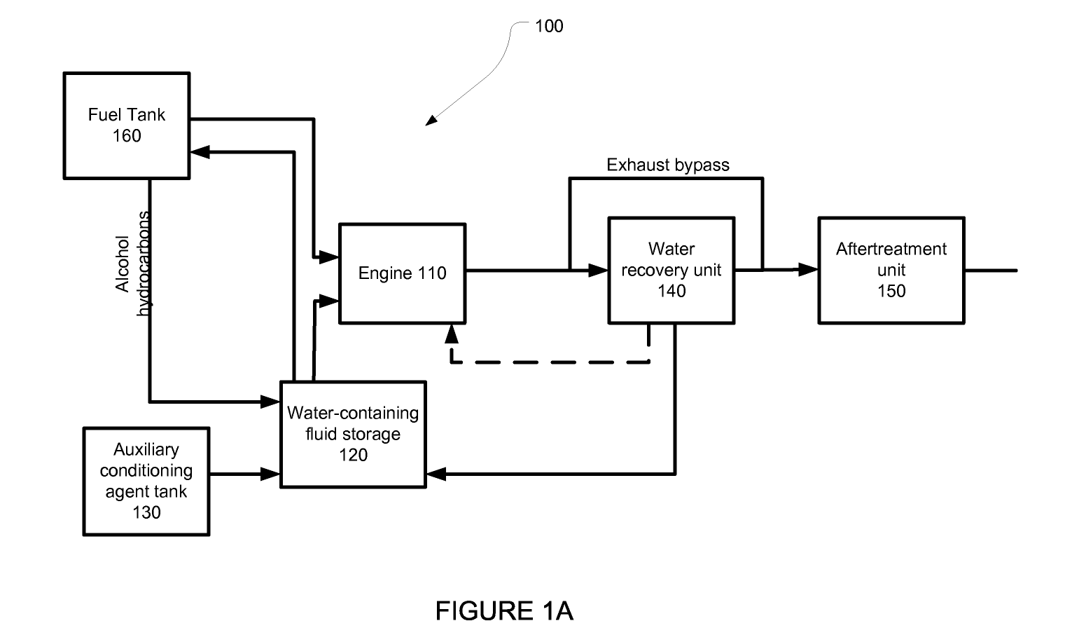

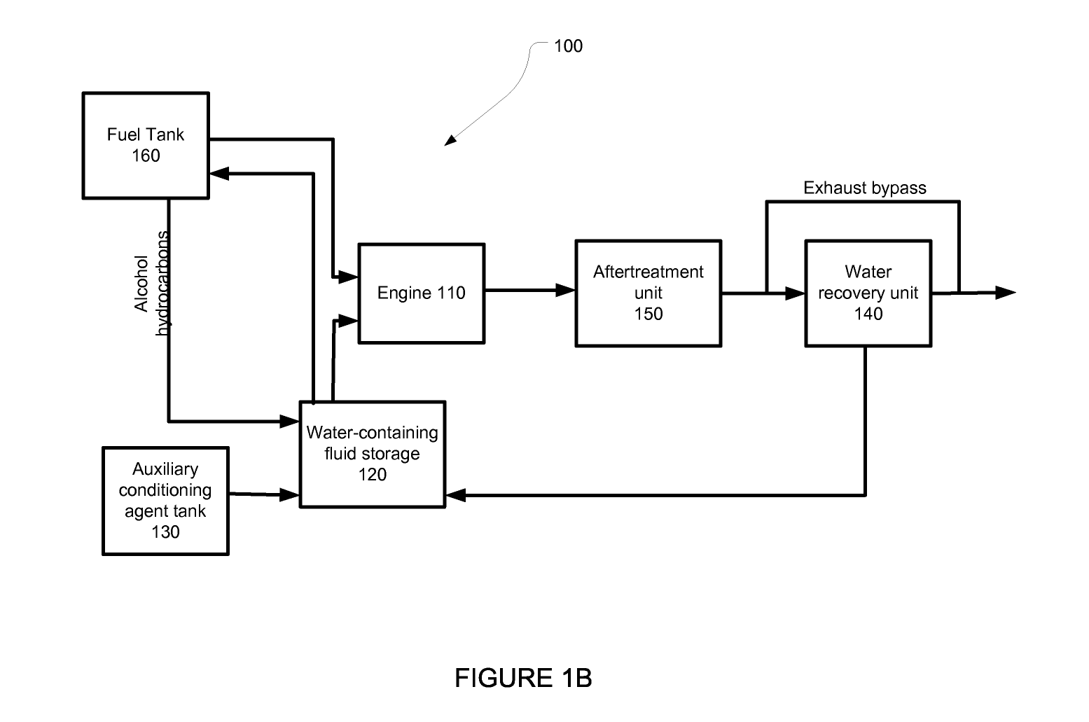

The invention describes a means of extracting the water contained within engine exhaust, optionally storing it for use at a later time, and optionally mixing it with ethanol from the gasoline. Furthermore, there are control systems to assure that enough water has been stored. FIG. 1a shows a first embodiment of the system 100.

The exhaust from engine 110 is used as a source of water, which is temporarily stored in an antiknock agent holding tank 120. The antiknock agent is a fluid that contains water. It may also include other fluids, such as ethanol, methanol, or other liquids. It is used to reduce the tendency of the engine to knock, particularly at higher values of torque. This tank 120 can be supplemented with alcohol that is extracted from the fuel, the alcohol being extracted either from a gasoline-ethanol mixture such as E10 in the fuel tank 160 or the gasoline-ethanol mixture that is being pumped to the injector. In some embodiments, fluid from tank 120 is pumped into fuel tank 160 in order to allow ethanol to separate from the gasoline/ethanol mixture in the fuel tank 160. In other embodiments, water from the water recovery unit 140 is pumped directly to the fuel tank 160 to allow ethanol to be separated from the fuel.

An auxiliary conditioning agent tank 130 may be used to provide fluids to adjust the characteristics of the water-containing fluid (such as lubricity, ph, and adjustment of the freezing temperature). The water-containing antiknock agent from tank 120 is injected into the engine 110 on demand, during conditions that benefit from the presence of an antiknock agent, such as water, or water-based fluids. In the case of gasoline engines, the water-containing antiknock agent is used to prevent knock. In the case of a diesel engine, the water-injection is used to minimize emissions.

The conditioning tank 130 may also contain externally added ethanol or an ethanol-water mixture. In operation, fuel from the fuel tank 160 is used to power the engine 110. The exhaust from the engine 110 enters the water recovery unit 140, where water is extracted from the exhaust. This collected water is fed back to the storage tank 120, which contains water-based anti-knock fluid. In some embodiments, the exhaust may bypass the water recovery unit 140, as shown in FIG. 1a. In addition to receiving water from water recovery unit 140, the tank 120 may also receive fluids from fuel tank 160 and auxiliary conditioning agent tank 130. As stated above, alcohol, which is extracted from the fuel in tank 160, can be added to the tank 120. In addition, the auxiliary tank 130 may contain any type of agent, including a lubricant, ethanol, pH modifying agent or other liquids. An aftertreatment unit 150 may be utilized after the water recovery unit 140.

In another embodiment, shown in FIG. 1b, the aftertreatment unit 150 is located upstream of the water recovery unit 140. The function of all components remains unchanged, however.

The ethanol or ethanol-water mixture (from either tank 160 or tank 130) can be added as needed to the water in the anti-knock agent holding tank 120. The amount that is added may be determined by the temperature so as to prevent freezing of the fluid in the anti-knock holding tank 120. It may also be determined by the ethanol level that is needed to prevent knock without causing misfire. The ethanol or ethanol-water mixture from the conditioning tank 130 can also be added to the fluid tank 120 when the demands of the engine 110 are such that there is not enough fluid in the fluid tank 120.

The fluid in the conditioning tank 130 can also contain agents that provide lubricity and adjust ph. In another embodiment, an additional small tank (not shown) is used in conjunction with the conditioning tank 130. In this way, the addition of the lubricity agent or ph adjusting agent can be controlled separately from the ethanol addition.

### Gasoline Engine Applications

In order to capture a sufficient amount of water, assuming that the water extracts most of the ethanol from an ethanol-gasoline mixture such as E10 and that an anti-knock agent flow rate of 20% of the gasoline flow rate is required, it can be seen that about 10% of the water from the exhaust needs to be condensed for steady state operation. Under these conditions, the water retrieved from the exhaust recovery unit 140, mixed with the ethanol extracted from the gasoline tank 160, is sufficient to provide the required antiknock agent for boosting at high torque, which is the most demanding situation for engine knock.

Because of the need to be able to extract the water at the same rate that it is being used at the high torque conditions, the system needs to be able to collect sufficient water even under the most demanding situations. This imposes demanding requirements on design of the water recovery unit 140. In some embodiments, the water can be condensed from the exhaust through the use of hydrophilic membranes, which may require high pressure operation. In another embodiment, the exhaust could be cooled by force flow cooling by ambient air through the use of a heat exchanger, which may be sufficient during normal operation in temperate weather. However, in some situations, such as hot days, large flows of coolant air may need to be used to cool the exhaust sufficiently to provide the required water. Therefore, on hot days, it may be necessary to use a small fraction of the vehicle's air conditioning system to cool enough of the exhaust to allow a sufficient amount of water to condense, thereby producing an adequate supply of water condensate for boosting the engine 110. In yet another embodiment, the water may be extracted through the use of an auto-heat exchanger, as will be described below.

The water, collected from the exhaust recovery unit 140, can be used to extract ethanol from a gasoline-ethanol mixture, such as E10, which is distributed in most service stations in the US. In some embodiments, the extracted ethanol can be used by the engine 110 in real time. Such a method has been described in U.S. patent application Ser. No. 12/610,403, the contents of which are herein incorporated by reference in its entirety. In addition, the use of water-alcohol mixtures for minimization of the volume of antiknock agent has also been described in the aforementioned patent application.

As described in the aforementioned patent application, the alcohol can be retrieved from the gasoline-alcohol blends by mixing the water and the gasoline as it is being pumped to the engine 110. After the mixing unit where the water and the gasoline are mixed, there is a separation device where the aqueous alcohol can be separated from the “alcohol diminished” gasoline, for example, by the difference in densities of the two phases. The alcohol-diminished gasoline fuels the engine 110. Though the octane rating of this alcohol-diminished gasoline may be modestly lowered by the reduced alcohol content, this deficiency could be more than made up by a smaller quantity of alcohol mixed with water injected directly into the cylinders.

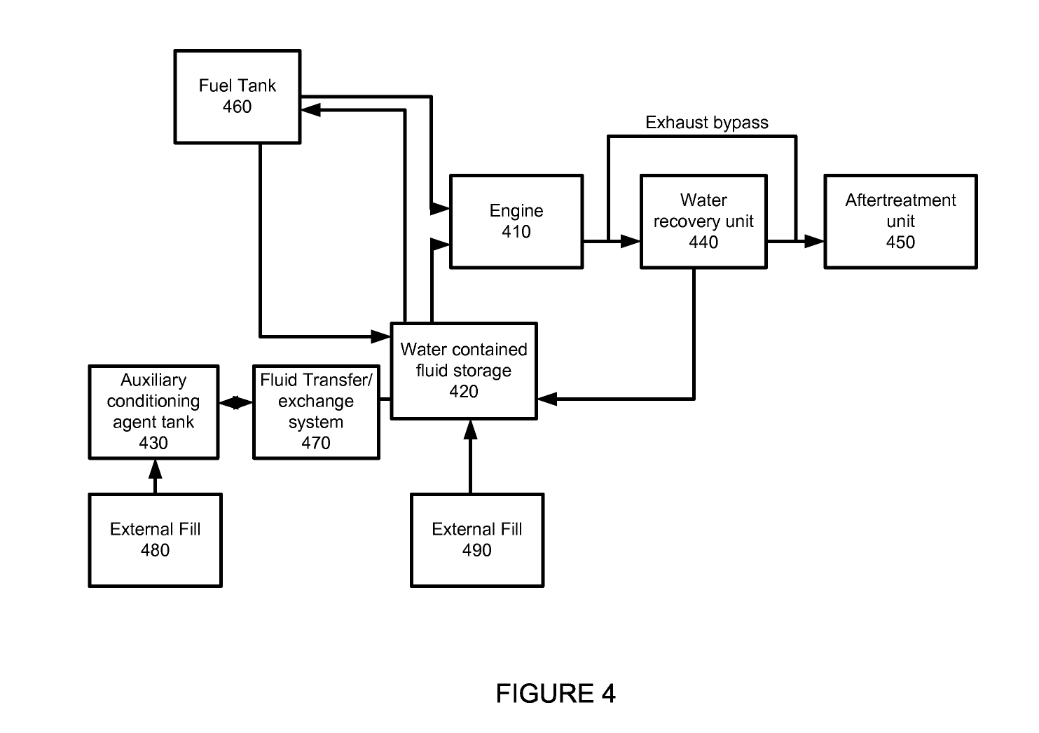

For operation of the engine 110 less demanding that those of prolonged towing at high torque, the aqueous alcohol from the separation device (within fuel tank 160) may go to a storage tank 120 from which it can be drawn by a separate pump to supply antiknock agent to the engine 110 as needed. This storage tank 120 for antiknock agent should be large enough to supply enough anti-knock fluid for most operation of the engine 110, including most expected long-duration periods of high torque and energy demands imposed upon the engine 110, such as high speed motoring against strong head winds, towing a heavy trailer, or extensive climbing. However, it is possible that there are some conditions where the antiknock agent needs to be replenished in real time. FIG. 4 shows how these options can be provided.

For most normal operations of the vehicle, it will be unnecessary to add any antiknock agent to the tank 120 and thus it should need no external feed of the antiknock agent, such as that provided through 490 in FIG. 4. Nevertheless, for extraordinary, or start up purposes, such as may be experienced by a new car, it may be necessary for some antiknock agent to be introduced from the outside to prime the system.

There are several options for achieving the recovery of the needed fraction of water from the exhaust. It is possible to remove the required amount from all the exhaust by removing a fraction of the water in the exhaust through the water condensing unit and leaving the rest of the water in the exhaust. For example, all of the exhaust may enter water recovery unit 140, which only removes a fraction of the total water content from the exhaust. In another embodiment, all of the water is removed from a fraction of the exhaust. For example, a portion of the exhaust may be passed through the water recovery unit 140, which extracts all of the water contained in this exhaust, while the rest of the exhaust is routed around the recovery unit 140. In addition, any combination of these options can be used.

It should be noted that for either gasoline or diesel, when water injection is used at the highest rate, such as around 10% of the fuel volume (with, for example, another 10% with ethanol extracted from the gasoline when the vehicle operates with gasoline/ethanol blends), the concentration of water in the exhaust is approximately doubled. For these peak conditions, the fraction of the exhaust that needs to be processed to remove the water decreases, because of the increased concentration of water in the exhaust.

A relatively small system is required to extract the required amount of water from the exhaust. The minimum energy that needs to be extracted from the exhaust is approximately the heat of condensation of the water, about 2200 kJ/kg. Only 10% of the water needs to be collected for the present application at the highest rates of antiknock agent injection. The mechanical energy produced by the gasoline assuming 25% engine efficiency, assuming that the equivalent SEER (seasonal energy efficiency ratio) of an air conditioner is about 10, the power required to cool the required water is less than about 1% of the mechanical power of the engine, for an efficiency penalty of about 1%.

The same calculations indicate that the minimum power required to remove most of the water from the exhaust (that is, to remove the heat of vaporization from the water), if all the cooling is done by the auto-heat-exchanger (that is, no direct heat exchanging to the outdoors), is around 10% of the mechanical power from the engine.

A method to remove the water from the exhaust is described below. This method is not intended to be exclusive of the other methods, which include membranes, chillers, heat exchangers, the use of hydrophilic fluids, and others. Rather, it is illustrative of one method that can be used. The water recovery unit 140 may be an auto-heat exchanger.

The use of an auto-heat exchanger can be used to accomplish the condensation of the water without having to provide the power required to cool the entire exhaust. In the auto-heat exchanger, the exhaust is cooled, the water is then collected from the exhaust, and the cool exhaust is used to cool the incoming waterlogged exhaust. This can be accomplished using fixed beds with valves as described in U.S. Pat. No. 7,384,454. Alternatively, it can be accomplished by using a moving bed, as described in U.S. Pat. No. RE37134. If the process is isentropic, the only energy that needs to be extracted from the system is that required for condensation of the water, which is described in the previous paragraph. However, there may be small inefficiencies, such as thermal conduction along the heat exchanger or flows across seals that will increase the electrical power requirement.

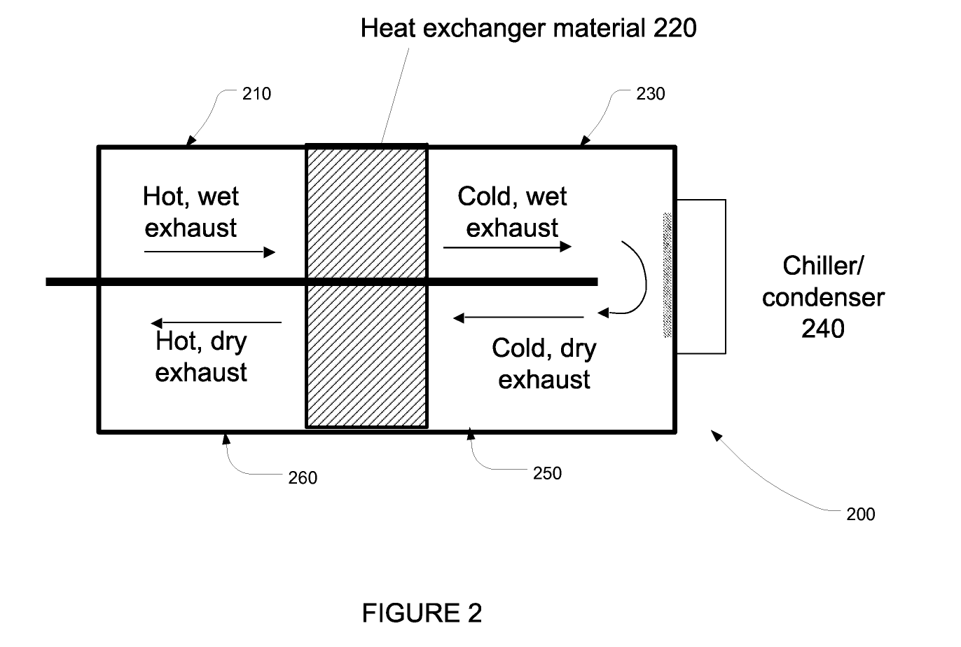

FIG. 2 shows a representative water recovery unit 140. In this embodiment, an auto-heat exchanger 200 is used. However, other devices may also be used to remove water from the exhaust and the invention is not limited to this embodiment. Hot wet exhaust enters a first portion 210 of the heat exchanger 200. This wet, hot exhaust then passes through a first section of heat exchanger material 220, where a portion of its thermal energy is removed. The resulting cold, wet exhaust then passes through a second portion 230 of the heat exchanger 200. The cold wet exhaust then passes near a chiller/condenser 240, where condensate is collected. The cold dry exhaust then enters a third portion 250 of the heat exchanger 200, and a second section of the heat exchanger material 220 is exposed to this cold dry exhaust. The cold dry exhaust is heated by the heat exchanger material 220, and exits the fourth portion 260 of the heat exchanger 200 as hot dry exhaust. The sections of the heat exchanger material 220 then alternate, so that, at a later time, the first section is exposed to the cold dry exhaust (flowing in the opposite direction). Similarly, the second section of the heat exchanger material 220 is exposed, at a later time, to the hot wet exhaust. The goal is to remove the water in the section of the heat exchanger material 220 near portion 230, or in a chiller/condenser unit 240 downstream from the heat exchanger material 220. Ideally, the temperature of the hot dry exhaust at the exit 260 of the heat exchanger 200 is the same or very close to that of the hot wet exhaust at the entrance 210 of the heat exchanger.

The means to alternate the flow of exhaust through the heat exchanger material 220 can be achieved by valving (a set of valves at the entrance that alternates the inlet/outlet at each section of the heat exchanger 200). Alternatively, it can be achieved by motion of the heat exchanger material 220, without the use of valves. The motion can be rotational. The heat exchanger material 220 can be a honeycomb catalyst, with either metallic or ceramic material. Because of the corrosive nature of the water collected, it may be useful to construct the heat exchanger material 220 from ceramics, such as those materials being used for catalyst support or diesel particulate traps, including corderite, mullite, silicon carbide.

It may be possible to provide the required cooling capability (i.e. the chiller/condenser 240) by using the vehicle's air conditioning, as only a small amount of cooling is required. However, during normal operation, it may be possible to use ambient air, eliminating the fuel penalty from the air conditioning.

The use of a moving heat exchanger material bed is facilitated by the fact that the temperatures are relatively low, and that the pressure differential between the two legs of the heat exchanger (i.e. 210/230 and 250/260) is very low. The issue of seals is thus substantially simplified.

The alternative approach of alternating the flows through the heat exchanger material 220 is through the use of valves. The seals in these valves do not have to be perfect, as some bypass should not affect the performance of the water condensation unit 200. Because of the low pressure drop between the two legs of the self-heat exchanger, there should little mixing of the two flows, even in the presence of small leaks.

The amount of water condensed in the system can be controlled by adjusting the flow rate of exhaust through the water recovery unit 140, such as by utilizing the exhaust bypass shown in FIG. 1. Alternatively, the amount of water collected can be controlled by adjustment of the temperature of the chiller/condenser 240. In some embodiments, if too much water is collected, it can be safely disposed of by releasing it to the environment.

In order to prevent running out of antiknock agent during prolonged towing, it is necessary to size the water condensation unit 140 at peak torque that corresponds to the highest demand of the antiknock agent. This occurs at intermediate speeds, as peak torque is reduced at higher speeds and there is reduced need for antiknock agent at these speeds, as calculated by Bromberg [Calculations of knock suppression in highly turbocharged Gasoline/ethanol engines using direct ethanol injection, L. Bromberg, D. R. Cohn, J. B. Heywood, MIT LFEE Report 2006-01], at low altitudes, with high outdoor temperatures.

It is possible to replace the chiller/condenser 240 shown in FIG. 2 with a method like those proposed by others, such as the use of hydroscopic fluid, or membranes. The reduced temperature in the region of water separation will help all of these methods achieve higher water collection efficiencies.

It is possible to control the amount of exhaust through the water recovery system 140 by either constricting the flow through the exhaust bypass, or by placing a blower in the cold region of the water separator.

The water retrieved from the exhaust may not be suitable for use in the engine 110, or with the fuel pump or with the fuel injector. For example, the condensed liquid may be highly acidic. A secondary tank 130 containing a conditioning agent may be needed. The purpose of this liquid may be to provide lubricity to the water-based antiknock fluid, to adjust its corrosive properties (for example, ph), or another purpose, such as to act as a surfactant if the extracted water is to be combined with the gasoline/alcohol prior to injection into the engine. In addition, the secondary liquid may serve the purpose of antifreeze.

However, it is possible that ethanol may be extracted from the gasoline (as taught by U.S. patent application Ser. No. 12/610,403), especially in batch processing with a water storage tank 120. In this embodiment, the alcohol may serve as the additive. In addition, there may be a small amount of hydrocarbons present in the antiknock fluid (alcohol/water), which may provide some lubricity to the fluid.

One of the advantages of retrieving water from the exhaust, as opposed to adding water externally, is that the characteristics of the liquid are better characterized. For example, it is possible that an operator may unknowingly introduce compounds that are hazardous to the engine (such as chlorine and fluorine, which is present in potable water distribution systems). By utilizing the collected water, the chemistry is better understood and controlled. Furthermore, although the collected water may be corrosive and may have low values of ph, can be properly conditioned prior to injection into the cylinder.

In some embodiments, it may be best to remove the water from the exhaust downstream from the aftertreatment system 150, such as shown in FIG. 1b, in order to minimize the presence of hydrocarbons in the water and to minimize any temperature loss that may affect the efficiency of the aftertreatment system 150. The aftertreatment system 150 can be a 3-way catalyst.

In other embodiments, if the water recovery unit 140 handles the entire flow, it may be useful to place it upstream from the catalyst 150, as shown in FIG. 1a. The large surface area of the water separator 140 may condense hydrocarbons (if cold), such as during cold start. The system can be designed so that the time constant for warming of the catalyst is shorter than that for warming the water separation units. Thus, the hydrocarbon emissions from cold start can be reduced.

In addition, in the case where the entire exhaust flows through the water-recovery unit 140, it may be useful to have the heat exchanger material 220, which has a large surface area, as a catalyst for aftertreatment. The catalyst material can be applied to the heat exchanger material 220 in an inhomogeneous manner, so that it is located preferentially in the region of higher temperature near the inlet and outlet region, away from the colder regions where the water is condensed.

Additional fluid from the conditioning tank 130 may be needed when the water recovery unit 140 is not operational. For example, it may take some amount of time after ignition to establish the temperature profile through the heat exchange material 220 necessary for water extraction.

One of the purposes of the additional liquid in the tank 130 may be to control sterility of the antiknock fluid, especially when the alcohol concentration in the fluid is small.

The volume requirement of this secondary conditioning agent is very small, and thus the refill interval of this tank 130 could be longer than that of regular maintenance of the engine 110.

In one embodiment of the invention, the antiknock fluid tank 120 may be large enough to be able to provide, in real time, an amount of antiknock agent that is equal or larger than the amount that is being consumed, through the engine operating range. This mode, for example, may be needed for continuous operation at high torque for prolonged towing.

In a second embodiment, a smaller tank 120 is employed, suggesting that there may not be enough agent for all operating conditions. This implies that, for some extreme conditions, the available antiknock agent is not enough to provide sustained operation without externally refilling the antiknock agent tank 120. In this case, there will be a limited range for the operation of the engine 110 in these conditions. However, for this case, extracting the water from the exhaust extends substantially the range of the vehicle.

In the absence of alcohol for operation with the water, such as when the gasoline does not contain any alcohol, the water can be used alone as an antiknock agent. However, the use of the water to prevent knock will eventually lead to decreasing the flame propagating speed and may result in misfire. In this case, the misfire will limit the torque, and the boosting. However, the limit on torque due to misfire is substantially higher than the knock level in the absence of any antiknock agent. Thus, the maximum torque level in the absence of ethanol is increased.

It is possible to inject the water and the gasoline/ethanol blend through the same injector. In this case, there is no need for separation of the ethanol from the gasoline, since they are ultimately all injected through a common injector. By real-time recovery of the water without or with limited storage of the water, the needs for antifreeze conditioning agent are minimized or eliminated. The injector can be a single nozzle/multiple valve injector, or multiple nozzles/multiple valves. Alternatively, the water and gasoline/ethanol blends may be mixed prior to injection into the engine 110 through a single injector with a single valve. The issues with respect to fast response from the injector in the case of premixed gasoline/ethanol/water are discussed in U.S. Pat. No. 7,640,913, the contents of which are herein incorporated by reference in their entirety. By combining the gasoline and the water close to the injector, it is possible to avoid the need of surfactants that could be used to emulsify a water/gasoline/alcohol mixture.

Thus, in one embodiment of the invention, the water that is extracted from the exhaust using the water recovery unit 140 is directly injected along with a gasoline-ethanol mixture, such as E10, using the same injector, as represented by the dashed line in FIG. 1a. The presence of ethanol in the fuel facilitates obtaining the required knock resistance without an amount of water that would prevent misfire. The amount of water that is used is limited by a control system (not shown) that uses a signal from a misfire detector to prevent too much from being used. Water that is not used can be allowed to drain out of the system that conducts it from the exhaust. If the gasoline does not contain an ethanol additive, both the amount of water that is used and the manifold pressure in the engine can be limited so as to prevent both knock and misfire.

Therefore, in this embodiment, a controller is used, which may receive information concerning the production of water from the water recovery unit 140, and the performance of the engine 110, including a knock and misfire sensor. In addition, the controller may receive information about the composition of the fuel in tank 160, so as to know whether ethanol is present in the fuel. Based on these inputs, the controller can regulate the flow of fuel and water into the engine 110, as needed.

In another embodiment, the extracted water is directly injected in an injector that is physically separate and separately controlled from the injector that injects gasoline or a gasoline ethanol mixture. However, if the gasoline-ethanol mixture is port fuel injected, the maximum torque that is possible while meeting both the misfire and knock prevention requirements would be lower than in the case of direct injection of the gasoline-ethanol mixture. Again, a control system such as that described above may be used to control the directly injected fluid. For both of these embodiments, when the amount of water that is extracted from the exhaust is not sufficient or is not available, ethanol or an ethanol-water mixture could be provided by a secondary tank. The amount of liquid that is provided by the secondary tank could be drastically reduced by use of the water extracted from the exhaust.

As stated above, it may be necessary to condition the condensate from the exhaust. In addition to adding conditioning agents, it may be necessary to remove solid matter and other contaminants. A filter can be used to remove solid matter. In addition, an absorbent may be used to remove chemicals. Charcoal could serve as such an absorber. The filter and/or absorber can be exchanged at regular maintenance intervals, as is done with fuel filters, air filters and oil filters. Such a filter system may be introduced between the water recovery unit 140 and the engine 110 or storage tank 120.

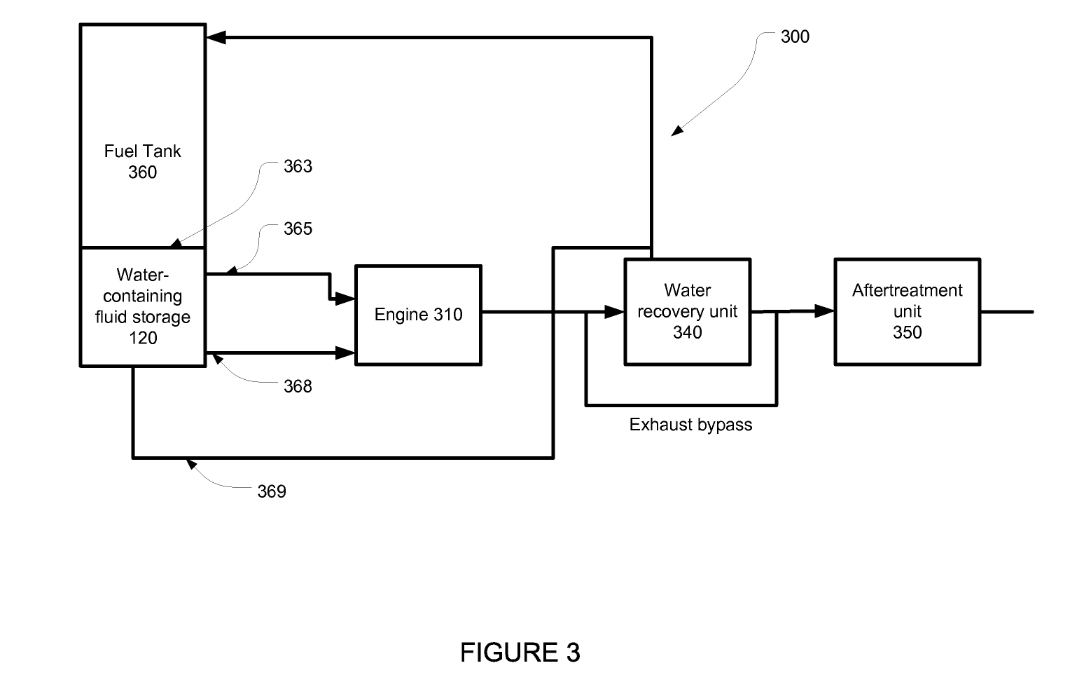

Another embodiment of the invention uses a single tank for the gasoline-alcohol fuel and the water-containing fluid that is employed to prevent knock, as shown in FIG. 3. This water-containing fluid is also referred to as the “alcohol-water boostant” (since it effectively boosts the octane of the fuel and the knock free power capability of the engine). In this embodiment, a single fuel tank 260 is used to contain both the fuel, and the water-containing fluid. Due to differences in density, the water-containing fluid will sink to the bottom of the tank 260. Thus, the intake 365 for alcohol-depleted gasoline going to fuel the engine 310 should be near the surface of the gasoline-alcohol mixture in the tank and be held fairly close to the center of the tank. In contrast, the alcohol-water boostant should be withdrawn from near the bottom of the tank 360. The alcohol-water boostant may be split into two streams. One stream 368 is used for boosting the engine 310. The other stream 369 is used for picking up the exhaust condensate from the water recovery unit 340. The collected water is then re-introduced into the tank 360 containing the gasoline, alcohol and water. The alcohol-water fluid with exhaust condensate will preferably be introduced on the surface of the fluid in the tank 360 in such a way that it will not seriously contaminate the engine's fuel, and will also extract an adequate amount of alcohol from the gasoline-alcohol fuel.

In another embodiment, only a single stream 368 exits the lower portion of tank 360 and is used for engine boost. Collected water from the water recovery unit 340 is fed into the fuel tank 360, without being mixed with a second stream.

The stream 368 of the water-alcohol mixture going to the engine for knock avoidance would be pumped under the control of a knock prevention system, such as those described in the above mentioned patent applications.

The second branch 369 of this alcohol water stream should be pumped to the exhaust water condenser where it can immediately be mixed with the water condensate. This water-diluted boostant should be pumped up to a pressure whereby it can be dispersed in a downward-pointing hollow-cone spray approximately centered on the floating gasoline-alcohol mixture engine fuel intake. This floating engine fuel intake should be held in the “hollow” of the hollow-cone spray.

If necessary, a small floating “hat” (not shown) can be installed over the gasoline-alcohol mixture intake in order to prevent spray droplets in unacceptable quantity be entrained with the alcohol-depleted gasoline going to fuel the engine.

To increase the rate of ethanol removal from the gasoline/ethanol blend, the spray droplets should be small enough in radius such that the alcohol that they extract from the gasoline-alcohol mixture can diffuse fast into the interior of each droplet as these droplets slowly settle through the gasoline-alcohol layer in the tank down into the boostant in the bottom of the tank 360.

Both the spray nozzle and the depleted gasoline-alcohol fuel intake should be held fairly near the center of the tank by vertically pivoting arms.

The interface 363 between the depleted gasoline-alcohol and the boostant should control a condensate discard valve when the level of the boostant in the tank rises approximately to the point where the boostant occupies 15% of the tank's volume. If this interphase level controlling device is based on its ability to float between the hydrocarbon and alcohol phases, the length of its supporting beam should prevent the float from swinging too close. The level can be controlled through a sensor. An RF sensor that measures dielectric properties could be used, or one that can measure electrical conductivity. The level can be controlled through addition of water to the tank. If there is too much water, it can be reduced by consuming some of it in the engine, even if it is not needed for controlling knock.

Another embodiment of this invention for direct injection octane boosting uses two externally filled tanks to provide variable ethanol-water mixtures for knock suppression. This embodiment is shown in FIG. 4. The first tank, or the conditioning tank 430, is for ethanol-based fluid or another anti-freeze agent and/or alcohol. The conditioning tank is refilled externally, using external fill port 480. The second tank 420 is for a water based octane boost fluid where the water that can be supplied externally, via external fill port 490, and/or recovered from the exhaust using the water recovery unit 440. This tank 420 supplies octane boost fluid to the fuel injectors. There are connections between the tanks 430, 420 such that ethanol can be transferred to the water-based tank 420 to provide a varying ethanol-water concentration. In this way, the ethanol concentration can be changed as needed to prevent freezing of the octane boost fluid and/or to provide a source of intrinsic rather than evaporative octane enhancement and thus avoid possible misfire. If necessary, fluid from the water-based tank 420 can also be transferred to the conditioning tank 430 in order to provide room for ethanol from the conditioning tank 430 to be transferred to the water-based tank 420, thus allowing for the exchange of fluids between the two tanks. An exchange system 470 may be used to facilitate the transfer of fluid between the tanks 420, 430. The ethanol that is used in the conditioning tank 430 could be in the form of E85 or could be in the form of an ethanol-water mixture

Another means to allow room for ethanol to be added to the octane boost fluid tank 420 is to insure that the octane boost fluid tank 420 is not completely full when water is added to it externally via external fill port 490, or by recovery from the engine exhaust.

The amount of ethanol that is transferred to the octane boost tank 420 can be determined by the need to prevent freezing. The ethanol concentration can be adjusted as a function of instantaneous temperature, temperature history or by active control by the driver or another individual. For example, as the temperature decreases and there is chance of freezing, antifreeze fluid from the ethanol tank 430 may be transferred to the water tank 420. The rate of introduction of the ethanol into the water tank 420 can also be determined by the operational history of the engine 410 in encountering misfire when the largest amounts of water are used at the highest torques.

The exchange/transfer system 370 between the two tanks 420, 430 may be comprised of one-way flow valve/pumps, two one-way flow valves/pumps, or it can be a single two-way flow valve/pump. The concentration of fluid in one or both tanks 420, 430 can be monitored by sensors, such as dielectric sensors (not shown).

A lubricity agent can be added to the either of these tanks 420, 430. In addition, anticorrosive fluids can also be added to either of these tanks.

Special tank, pipe, pump and valve materials may be needed, in order to prevent corrosion and oxidation. Due to the low ignitability of the fluids, plastic tanks can be used. Plastic-lined tanks can also be used.

The systems that are described above can be used with spark ignition engines that operate on a variety of fuels, including but not limited to natural gas and propane as well as gasoline and gasoline-ethanol mixtures. In the case of natural gas and propane, there would, of course, be no ethanol extraction from the fuel. With either natural gas or propane, the water concentration increases in the exhaust, simplifying the water extraction process. Although ethanol-gasoline blends are mentioned, other blends of gasoline and alcohol are also covered by the invention. These other alcohols include methanol and butanol.

### Diesel Engine Applications

Although only gasoline applications have been described above, it is possible to use water injection to reduce diesel emissions. Water injection in diesel engines has been proposed in the past. The present approach could also be used with diesel, with the water injected with the diesel or alternatively injected prior to diesel injection. The water will provide lower temperatures near the region of the diffusion flame, reducing both NOx and soot.

It may be more difficult to remove the water from the system, as diesel engines run leaner than gasoline engines, resulting in lower water concentration in the exhaust. Therefore, larger volumes of exhaust need to be handled in order to remove the required amount of water. Thus, the need for efficient water collections, as described with the use of the auto-heat exchanger, is very attractive. It can be advantageous to locate the exhaust water extraction system after a diesel particulate filter to minimize any adverse effects of particulates on the heat exchanger, as shown in FIG. 1b.

It may be attractive to use water as the fluid for diluting the air/fuel mixture. For a given amount of thermal dilution, water requires less mass (and less volume) than EGR, because of the tri-atomic nature of the water. Lower amounts of the dilution decrease the requirements in the turbocharger and in the engine. Further, it is possible to stratify the water in cylinder, through late injection of liquid water, through a separate injection process. Water should be in the region where the diffusion flame is located for maximum effect and for minimum requirement. The water can be injected through the same nozzle, or through a different nozzle, in the same injector or in a separate injector.

By stratifying the water injection it will be possible to decrease the amount of water required for emission control.

In the case of a diesel engine, it is unlikely that the fuel will contain ethanol. However, it would be attractive to combine the water obtained from the exhaust with hydrocarbons from the diesel fuel, that may act as lubricants. In this case, the auxiliary conditioner tank will be needed to provide antifreeze, although the system can be sized so that most of the water is used in real-time, with little water storage capability, thus minimizing the amount of conditioning agent.

The presence of water may also facilitate other powertrain concerns, such as better aftertreatment performance.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A system for providing a water-ethanol mixture for introduction into a spark ignition engine where the water in said mixture is removed from the engine exhaust and employed to extract ethanol from a gasoline-ethanol mixture contained in a fuel tank, and wherein the resulting ethanol-water mixture is introduced into said engine.

2. The system of claim 1, where the water-ethanol mixture is directly injected into said engine.

3. The system of claim 1, where fluid that is externally supplied to a second tank, separate from said fuel tank, is also introduced into said engine.

4. The system of claim 1, where said water is extracted from said exhaust using cooling provided by an air conditioner.

5. The system of claim 1, where an auto-heat exchanger is used to extract said water from said exhaust.

6. The system of claim 1, where said engine is fueled with gasoline and said gasoline and said water are both directly injected into said engine through a single injector.

7. The system of claim 1, where a conditioning fluid is supplied to said engine and stored in a separate tank.

8. The system of claim 7, where said conditioning fluid increases the lubricity of the water.

9. The system of claim 1, where the water is removed upstream from a catalyst.

10. The system of claim 1 where the water is removed downstream from a catalyst.

11. An engine system where water that is extracted from engine exhaust is directly injected into said engine and where the amount of water that is employed is sufficiently high so as to prevent knock while being low enough to prevent misfire.

12. The engine system of claim 11, where said water is injected in an injector which also directly injects gasoline.

13. The engine system of claim 11, where said water is injected in an injector which also directly injects an ethanol-gasoline mixture.

14. The engine system of claim 11, where a tank which is separate from the fuel tank provides ethanol or an ethanol-water mixture which can be employed in addition to or instead of said water that is extracted from the exhaust.

15. The engine system of claim 11, where said water is extracted by using an auto heat exchanger.

16. The engine system of claim 15, where the auto heat exchanger is a moving bed.

17. The engine system of claim 11, where said water extraction occurs before an exhaust aftertreatment system.

18. The engine system of claim 11, where the water extraction occurs after an exhaust aftertreatment system.

19. The engine system of claim 11, where a conditioner is added to said water before it is injected into said engine.

20. The engine system of claim 11, where the maximum manifold pressure is reduced when the amount of water that can be used to prevent knock is limited by misfire.

21. An engine system where water is extracted from the engine exhaust and is stored in a first fluid tank and where ethanol or an ethanol water mixture from a second conditioning tank is added to the fluid in the first fluid tank and where the fluid in the first fluid tank is introduced into said engine.

22. The engine system of claim 21, where the amount of said ethanol or ethanol-water mixture that is added from said second conditioning tank is varied as a function of temperature.

23. The engine system of claim 21, where the amount of said ethanol or ethanol-water mixture that is added from said second conditioning tank is varied as a function of the amount of ethanol in said first fluid tank.

24. The engine system of claim 21, where said fluid in the first fluid tank is directly injected into a spark ignition engine.

25. The engine system of claim 21, where said fluid in the first fluid tank is introduced into a diesel engine so as to reduce emissions.

26. The engine system of claim 21, where said water is extracted from said exhaust by use of a moving auto heat exchanger.

27. The engine system of claim 21, where said ethanol or ethanol-water mixture from said second conditioning tank is added to said first fluid tank when there is not an adequate amount of fluid in said first fluid tank to meet the needs of said engine.

28. The engine system of claim 21, where a lubricity agent from said second conditioning tank is added to said first fluid tank.

29. The engine system of claim 21, comprising a second tank containing ethanol, where a lubricity agent from a third tank, separate from said second tank, is added to said first fluid tank.

30. The engine system of claim 21, where ethanol is extracted from an ethanol-gasoline mixture and is stored in an ethanol-water mixture in said first fluid storage tank.

31. The engine system of claim 21, where said engine is fueled with gasoline.

32. The engine system of claim 21, where said engine is fueled with natural gas.

33. An engine system where water is extracted from the exhaust using a moving auto heat exchanger.

34. A engine system, where a first tank provides water or a mixture of water and a second fluid for direct injection into said engine and where a second tank is filled with said second fluid and where said first and second tank are connected in such a way that said second fluid in said second tank can be added to said first tank to provide varying mixtures of water from said first tank and said second fluid from said second tank.

35. The engine system of claim 34, where said water in said first tank is provided by a source external to the vehicle.

36. The engine system of claim 34, where said water in said first tank is provided by water that is recovered from the engine exhaust.

37. The engine system of claim 34, where said first tank contains water that is provided by an external source and water that is recovered from the engine exhaust.

38. The engine system of claim 34, where the amount of said second fluid from the second tank that is added to said first tank is determined by temperature.

39. The engine system of claim 34, where room for adding said second fluid from said second tank to said first tank is provided by not filling said first tank completely.

40. The engine system of claim 34, where room for adding said second fluid from said second tank to said first tank is provided by transferring some of said fluid from said first tank to said second tank.

41. The engine system of claim 34, where said second tank contains E85.

42. The engine system of claim 34, where the addition of said fluid from said second tank is determined by the requirement to increase the intrinsic octane of the fluid in said first tank.

43. The engine system of claim 34, where said fluid in said second tank is ethanol.
